(19) United States
(12) Patent Application Publication
(10) Pub. No.: US 2014/0025979 A1
(43) Pub. Date: Jan. 23, 2014

(54) INTERFACE DEVICE AND INTERFACE METHOD

(71) Applicant: PANASONIC CORPORATION, Osaka (JP)

(72) Inventors: Mikio YAGI, Kanagawa (JP); Hirotaka ITOU, Osaka (JP); Akira MARUKO, Osaka (JP)

(73) Assignee: PANASONIC CORPORATION, Osaka (JP)

(21) Appl. No.: 14/035,722

(22) Filed: Sep. 24, 2013

Related U.S. Application Data
(63) Continuation of application No. PCT/JP2012/001648, filed on Mar. 9, 2012.

(30) Foreign Application Priority Data
Apr. 1, 2011 (JP) 2011-081832

(51) Int. Cl. G06F 1/32

(52) U.S. Cl. CPC G06F 1/3293
USPC 713/323

(57) ABSTRACT

A command determiner does not send a master command which it has received from a master device through a first interface circuit to a slave device if it determines that the master command does not need to be relayed. In this case, a power controller sets the power mode of a second interface circuit to a low power mode, and a response controller sends, as a slave command, a substitute command corresponding to the master command, which the command determiner has received from the master device through the first interface circuit, to the master device through the first interface circuit.

### CROSS-REFERENCE TO RELATED APPLICATIONS

This is a continuation of International Application No. PCT/JP2012/001648 filed on Mar. 9, 2012, which claims priority to Japanese Patent Application No. 2011-081832 filed on Apr. 1, 2011. The entire disclosures of these applications are incorporated by reference herein.

### BACKGROUND

The technology disclosed in this specification relates to interface devices interfacing between a master device and a slave device, and more specifically, to a technique for reducing power consumed by such interface devices.

Currently, along with lower power consumption of systems, it has been considered to reduce power consumed by not only device bodies constituting the systems, but also interfaces connecting the devices together. For example, serial ATA standards define a normal power mode (PHY_READY) and two low power modes (Partial, Slumber) in order to reduce power consumed by serial ATA interfaces when a relay such as data transfer between devices is not performed. In a serial ATA standard, if a return time period from Partial mode to PHY_READY mode is within 10 μ/sec and the return time period from Slumber mode to PHY_READY mode is within 10 m/sec, it is possible to determine any portion of the device and the interface to save power consumption.

As one example of a technique for controlling power of such interfaces, Japanese Patent No. 4371739 discloses that, in a SATA interface control circuit (interface converter) provided between an ATA interface and a serial ATA interface, when the circuit detects issuance or receipt of a sleep command allowing the mode of the ATA interface to transition to a low power mode, the serial ATA interface also transitions to a low power mode. Moreover, Japanese Patent No. 4371739 discloses starting to measure a time whenever the serial ATA interface transitions to an idle mode (normal power mode) in response to receipt of a command which requires interface conversion, and allowing the serial ATA interface to transition from the idle mode to a predetermined low power mode if no further command is sent even after a preset time is measured.

There are many interfaces connecting devices together such as USB interfaces, and IEEE 1394 interfaces in addition to serial ATA interfaces and ATA interfaces.

### SUMMARY

If a master device controls a slave device by sending or receiving a command between the master device and the slave device (for example, between a host computer and a peripheral device), a start timing at which a command is sent or received is determined by the master device. The same command may be repeatedly sent or received between the master device and the slave device depending on the operational state of the slave device. For example, while the slave device transitions from an operational state which does not allow access to the slave device to an operational state which allows access to the slave device, sending an access request command by the master device and sending an access negative acknowledgement command by the slave device are alternately repeated. Therefore, like Japanese Patent No. 4371739, even if the power mode of the slave device transitions to the low power mode if no command is sent from the master device during the preset time, the power mode of the slave device is returned to the normal power mode in order that the slave device can send a response command whenever a command is sent from the master device. Moreover, if a time interval between sending a master command and sending a next master command from the master device is shorter than a predetermined time set in advance, the power mode of the slave device cannot transition to the low power mode.

If the interface device interfaces between the master device and the slave device, the power mode of an interface circuit (an interface circuit connected to the slave device through an interface) included in the interface device and corresponding to the slave device is returned to the normal power mode every time when a command is sent from the master device. If a time interval between sending a master command and sending a next master command from the master device is shorter than a predetermined time set in advance, the power mode of the interface circuit corresponding to the master device cannot transition to the low power mode.

In this way, even if the same command is repeatedly sent or received between the master device and the slave device, the power mode of the interface circuit is returned to the normal power mode every time when a command is sent from the master device. Therefore, the low power period of the interface circuit, (a period during which the interface circuit is maintained in the low power mode) is intermittent, and it is difficult to efficiently reduce power consumed by the interface device.

It is an object of the technology disclosed in this specification to efficiently reduce power consumed by an interface device that interfaces between a master device and a slave device.

According to an aspect of the technology disclosed in this specification, an interface device interfacing between a master device and a slave device includes: a first interface circuit connected to the master device through a first interface; a second interface circuit connected to the slave device through a second interface, and switchable between a normal power mode and a low power mode; a command determiner configured to determine whether or not a master command needs to be relayed from the master device to the slave device based on device state information specifying an operational state of the slave device, configured to send the master command, which the command determiner has received from the master device through the first interface circuit, to the slave device through the second interface circuit if the command determiner determines that the master command needs to be relayed, and configured not to send the master command, which the command determiner has received from the master device through the first interface circuit, to the slave device if the command determiner determines that the master command does not need to be relayed; a power controller configured to set a power mode of the second interface circuit to the normal power mode if the command determiner determines that the master command needs to be relayed, and configured to set the power mode of the second interface circuit to the low power mode if the command determiner determines that the master command does not need to be relayed; and a response controller configured to send a slave command, which the response controller has received from the slave device through the second interface circuit, to the master device through the first interface circuit if the command determiner determines that the master command needs to be relayed, and configured to send, as the slave command, a substitute command corresponding to the master command, which the command determiner has received from the master device through the first interface circuit, to the master device through the first interface circuit if the command determiner determines that the master command does not need to be relayed.

In the interface device, if the master command does not need to be relayed, the substitute command corresponding to the master command is sent, and therefore, the power mode of the second interface circuit may not be returned to the normal power mode in order to send the master command to the slave device. Therefore, since the low power period of the second interface circuit (a period during which the power mode is maintained in the low power mode) can be continuously ensured, the power consumed by the second interface circuit can be efficiently reduced, and as a result, the power consumed by the interface device can be reduced.

The device state information may specify whether or not access to the slave device is allowed, and the command determiner may be configured to determine that the master command needs to be relayed if the slave device is in an operational state which allows the access to the slave device, and may be configured to determine that the master command does not need to be relayed if the slave device is in an operational state which does not allow the access to the slave device. For example, the slave device may include a storage device in which a storage medium is loadable, the device state information may specify whether or not the storage medium is loaded in the storage device, and the command determiner may be configured to determine that the master command needs to be relayed if the storage medium is loaded in the storage device, and may be configured to determine that the master command does not need to be relayed if the storage medium is not loaded in the storage device. The slave device may include a storage device which spins up a storage medium to read or write data of the storage medium, the device state information may specify whether or not the spin up of the storage medium has been completed, and the command determiner may be configured to determine that the master command needs to be relayed if the spin up of the storage medium has been completed, and may be configured to determine that the master command does not need to be relayed if the spin up of the storage medium has not been completed.

The response controller may include a command mapping table associating the master command from the master device with the slave command from the slave device, and may be configured to select, from the command mapping table, as the substitute command, the slave command corresponding to the master command, which the command determiner has received from the master device through the first interface circuit, if the command determiner determines that the master command does not need to be relayed.

According to another aspect of the technology disclosed in this specification, an interface device interfacing between a master device and a plurality of slave devices includes: a first interface circuit connected to the master device through a first interface; a plurality of second interface circuits each connected to a corresponding one of the slave devices through a corresponding one of a plurality of second interfaces and switchable between a normal power mode and a low power mode; a command determiner configured to determine whether or not a master command needs to be relayed from the master device to each of the slave devices based on device state information specifying an operational state of each of the slave devices, configured to send the master command, which the command determiner has received from the master device through the first interface circuit, to one of the slave devices which has been determined to need a relay of the master command through a corresponding one of the second interface circuits if the one of the slave devices is designated as a command destination of the master device, and configured not to send the master command, which the command determiner has received from the master device through the first interface circuit, to one of the slave devices which has been determined not to need a relay of the master command if the one of the slave devices is designated as a command destination of the master device; a power controller configured to set a power mode of one or more of the second interface circuits corresponding to one or more of the slave devices which have been determined to need the relay of the master command to the normal power mode, and configured to set a power mode of one or more of the second interface circuits corresponding to one or more of the slave devices which have been determined not to need the relay of the master command to the low power mode; and a response controller configured to send a slave command, which the response controller has received from the one of the slave devices which has been determined to need the relay of the master command through the corresponding one of the second interface circuits, to the master device through the first interface circuit if the one of the slave devices is designated as a command destination of the master device, and configured to send, as the slave command, a substitute command corresponding to the master command, which the command determiner has received from the master device through the first interface circuit, to the master device through the first interface circuit if the one of the slave devices which has been determined not to need the relay of the master command is designated as a command destination of the master device.

In the interface device, if the master command does not need to be relayed, the substitute command corresponding to the master command is sent, and therefore, the power mode of the second interface circuit may not be returned to the normal power mode in order to send the master command to the slave device designated as the command destination. Therefore, since the low power period of the second interface circuit can be continuously ensured, the power consumed by the second interface circuit can be efficiently reduced, and as a result, the power consumed by the interface device can be reduced.

The power controller may be configured to set the power mode of the one of the second interface circuits corresponding to the one of the slave devices which has been designated as the command destination of the master device to the normal power mode, and may be configured to set the power mode of the one or more of the second interface circuits corresponding to the one or more of the slave devices which have not been designated as the command destination of the master device to the low power mode.

With such a configuration, the power consumed by the one or more of the second interface circuits corresponding to the one or more of the slave devices which is not designated as a command destination can be efficiently reduced, and as a result, the power consumed by the interface device can be reduced.

According to another aspect of the technology disclosed in this specification, a method of interfacing between a master device and a slave device by using an interface device which includes a first interface circuit connected to the master device through a first interface, and a second interface circuit connected to the slave device through a second interface and switchable between a normal power mode and a low power mode includes the steps of: (a) determining whether or not a master command needs to be relayed from the master device to the slave device based on device state information specifying an operational state of the slave device; (b) setting a power mode of the second interface circuit to the normal power mode if it is determined that the master command needs to be relayed in the step (a), and setting the power mode of the second interface circuit to the low power mode if it is determined that the master command does not need to be relayed in the step (a); (c) sending the master command, which has been received from the master device through the first interface circuit, to the slave device through the second interface circuit, and sending a slave command, which has been received from the slave device through the second interface circuit, to the master device through the first interface circuit, if it is determined that the master command needs to be relayed in the step (a); and (d) sending, as the slave command, a substitute command corresponding to the master command, which has been received from the master device through the first interface circuit, to the master device through the first interface circuit without sending the master command to the slave device, if it is determined that the master command does not need to be relayed in the step (a).

In the above interface method, if the master command does not need to be relayed, the substitute command corresponding to the master command is sent, and therefore, the power mode of the second interface circuit may not be returned to the normal power mode in order to send the master command to the slave device. Therefore, since the low power period of the second interface circuit can be continuously ensured, the power consumed by the second interface circuit can be efficiently reduced, and as a result, the power consumed by the interface device can be reduced.

According to another aspect of the technology disclosed in this specification, a method of interfacing between a master device and a plurality of slave devices by using an interface device which includes a first interface circuit connected to the master device through a first interface, and a plurality of second interface circuits each connected to a corresponding one of the slave devices through a corresponding one of a plurality of second interfaces and switchable between a normal power mode and a low power mode includes the steps of: (a) determining whether or not a master command needs to be relayed from the master device to each of the slave devices based on device state information specifying an operational state of each of the slave devices; (b) setting a power mode of one or more of the second interface circuits corresponding to one or more of the slave devices which have been determined to need the relay of the master command in the step (a) to the normal power mode, and setting a power mode of one or more of the second interface circuits corresponding to one or more of the slave devices which have been determined not to need the relay of the master command in the step (a) to the low power mode; (c) sending the master command, which has been received from the master device through the first interface circuit, to the one of the slave devices through the corresponding one of the second interface circuits, and sending a slave command, which has been received from the one of the slave devices through the corresponding one of the second interface circuits, if the one of the slave devices which has been determined to need the relay of the master command in the step (a) is designated as a command destination of the master device; and (d) sending, as the slave command, a substitute command corresponding to the master command, which has been received from the master device through the first interface circuit, to the master device through the first interface circuit without sending the master command to the one of the slave devices, if the one of the slave devices which has been determined not to need the relay of the master command in the step (a) is designated as a command destination of the master device.

In the above interface method, if the master command does not need to be relayed, the substitute command is sent, and therefore, the power mode of the second interface circuit may not be returned to the normal power mode in order to send the master command to the slave device designated as a command destination. Therefore, since the low power period of the second interface circuit can be continuously ensured, the power consumed by the second interface circuit can be efficiently reduced, and as a result, the power consumed by the interface device can be reduced.

### BRIEF DESCRIPTION OF THE DRAWINGS

FIG. 1 is a view illustrating an example configuration of an interface device according to a first embodiment.

FIG. 2 is a flow chart illustrating the operation of the interface device illustrated in FIG. 1.

FIG. 3 is a sequence diagram specifically illustrating the operation of the interface device illustrated in FIG. 1.

FIG. 4 is a sequence diagram specifically illustrating the operation of the interface device illustrated in FIG. 1.

FIG. 5 is a sequence diagram illustrating the operation of a comparative example (an interface device having no function of determining whether or not a relay is needed and no representative response function).

FIG. 6 is a sequence diagram illustrating a stepwise power control.

FIG. 7 is a view illustrating an example configuration of an interface device according to a second embodiment.

FIG. 8 is a flow chart illustrating the operation of the interface device illustrated in FIG. 7.

FIG. 9 is a flow chart illustrating the operation of the interface device illustrated in FIG. 7.

FIG. 10 is a flow chart illustrating a modification of the operation of the interface device illustrated in FIG. 7.

### DETAILED DESCRIPTION

Embodiments will be described hereinafter in detail with reference to the accompanying drawings. It should be noted that the same or corresponding components are denoted by the same reference characters throughout the drawings, and that description of such components will not be repeated.

### First Embodiment

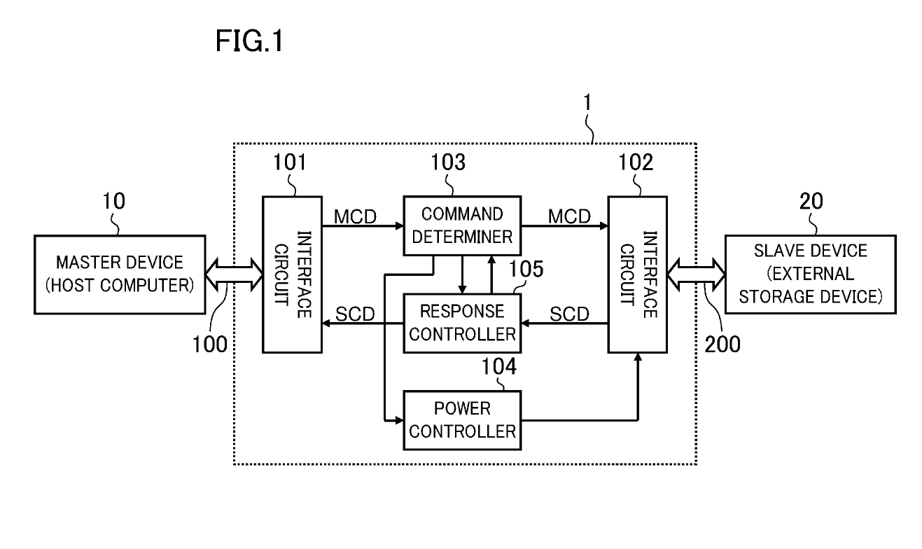

FIG. 1 is a view illustrating an example configuration of an interface device 1 according to a first embodiment. The interface device 1 interfaces between a master device 10 and a slave device 20, and includes interface circuits 101 and 102, a command determiner 103, a power controller 104, and a response controller 105.

Master Device, Slave Device

The master device 10 sends a master command MCD controlling the slave device 20 to the slave device 20 through the interface device 1. The slave device 20 sends a slave command SCD corresponding to the response result of the master command MCD to the master device 10 through the interface device 1. In this way, a command is sent or received between the master device 10 and the slave device 20, whereby the master device 10 controls the slave device 20. For example, the master device 10 may be a host computer, and the slave device 20 may be a peripheral device such as an external storage device (for example, an optical disc drive, a tape drive, a removable disk drive, a memory card drive). The master command MCD may be an access request command that requests access to the slave device 20. The slave command SCD may be a command specifying whether or not the access to the slave device 20 is allowed (for example, an access acknowledgement command and an access negative acknowledgement command).

Interface Circuit

The interface circuit 101 is connected to the master device 10 through the interface 100, and the interface circuit 102 is connected to the slave device 20 through the interface 200. The interface circuit 102 is switchable between a normal power mode and a low power mode. When the power mode of the interface circuit 102 is set to the normal power mode, the interface circuit 102 can send or receive a command (e.g., a master command MCD, a slave command SCD) to or from the slave device 20. When the power mode of the interface circuit 102 is set to the low power mode, the power consumption in this mode is lower than the power consumption in the normal power mode. However, the interface circuit 102 set to the low power mode has a power enough to be able to send or receive a predetermined command between the interface circuit 102 and the slave device 20 (for example, a state notification command notifying the change of the operational state of the slave device 20, and a return instruction command instructing the device to return from the low power mode to the normal power mode). In this embodiment, the slave device 20 is switchable between the normal power mode and the low power mode as well as the interface circuit 102.

For example, when the interface 200 is a serial ATA interface, PHY_READY mode which corresponds to the normal power mode, and Partial mode and Slumber mode which correspond to the low power mode are defined as the power mode of the interface circuit 102 and the power mode of the slave device 20. The power consumption in Partial mode is lower than that in PHY_READY mode, and the power consumption in Slumber mode is lower than that in Partial mode. In the serial ATA standard, if a return time period from Partial mode to PHY_READY mode is within 10 μ/sec and the return time period from Slumber mode to PHY_READY mode is within 10 μ/sec, it is possible to determine any portion of the interface circuit 102 and the slave device 20 to save power consumption.

The interfaces 100 and 200 may not be the serial ATA interface, and may be another interface such as an ATA interface, a USB interface, an IEEE 1394 interface. The standard of the interface 100 may be different from that of the interface 200. For example, the interface 100 may be a USB interface, and the interface 200 may be a serial ATA interface. In this case, at least one of the interface circuits 101 and 102 may have an interface conversion function (a function of converting data conforming to the standard of the interface 100 to data conforming to the standard of the interface 200, and a function of converting data conforming to the standard of the interface 200 to data conforming to the standard of the interface 100). The standard of the interface 100 may be the same as that of the interface 200.

Command determiner

The command determiner 103 determines whether or not the master command MCD needs to be relayed from the master device 10 to the slave device 20 based on device state information specifying the operational state of the slave device 20. The device state information will be described later. The command determiner 103 controls the relay of the master command MCD from the master device 10 to the slave device 20 in response to the determination result of the necessity of the relay of the master command MCD. If it is determined that the master command MCD needs to be relayed, the command determiner 103 sends the master command MCD, which the command determiner 103 has received from the master device 10 through the interface circuit 101, to the slave device 20 through the interface circuit 102. If it is determined that the master command MCD does not need to be relayed, the command determiner 103 does not send the master command MCD, which the command determiner 103 has received from the master device 10 through the interface circuit 101, to the slave device 20.

Power Controller

The power controller 104 controls the power mode of the interface circuit 102 in response to the determination result by the command determiner 103. If the command determiner 103 determines that the master command MCD needs to be relayed, the power controller 104 sets the power mode of the interface circuit 102 to the normal power mode. If the command determiner 103 determines that the master command MCD does not need to be relayed, the power controller 104 sets the power mode of the interface circuit 102 to the low power mode.

Response Controller

The response controller 105 controls the relay of the slave command SCD from the slave device 20 to the master device 10 in response to the determination result by the command determiner 103. If the command determiner 103 determines that the master command MCD needs to be relayed, the response controller 105 sends the slave command SCD, which the response controller 105 has received from the slave device 20 through the interface circuit 102, to the master device 10 through the interface circuit 101. If the command determiner 103 determines that the master command MCD does not need to be relayed, the response controller 105 sends, as a slave command SCD, a substitute command corresponding to the master command MCD, which the command determiner 103 has received from the master device 10 through the interface circuit 101, to the master device 10 through the interface circuit 101.

The response controller 105 may include a command mapping table which associates the master command MCD from the master device 10 with the slave command SCD from the slave device 20. In this case, if the command determiner 103 determines that the master command MCD does not need to be relayed, the response controller 105 may select, from the command mapping table, as a substitute command, the slave command SCD corresponding to the master command MCD, which the command determiner 103 has received from the master device 10 through the interface circuit 101.

Operation

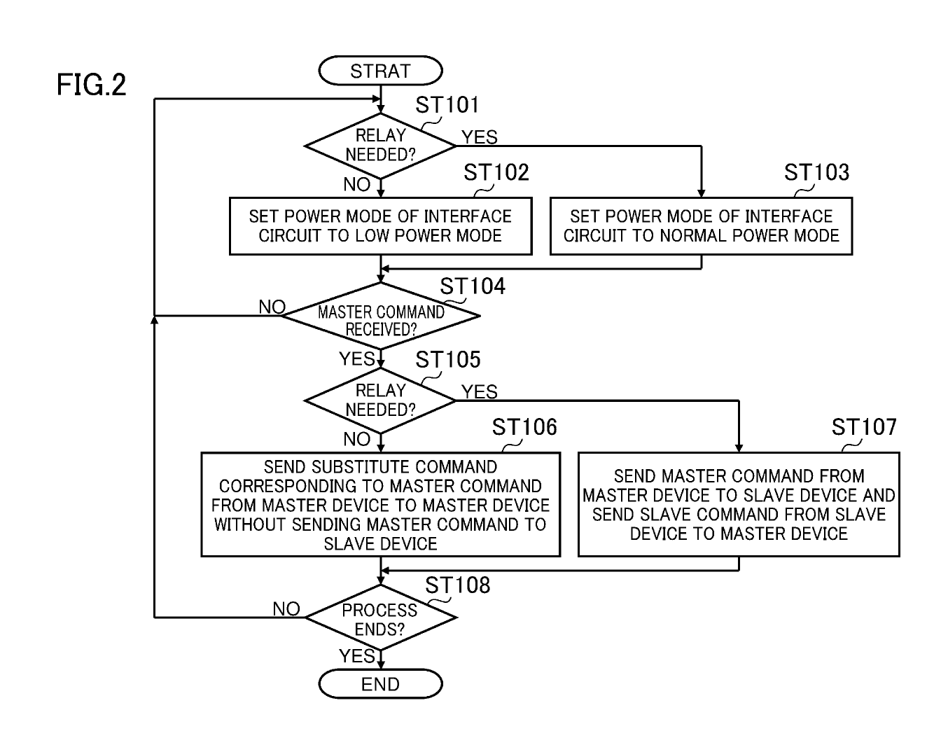

Next, the operation of the interface device 1 will be described with reference to FIG. 2. The command determiner 103 determines whether or not the master command MCD needs to be relayed based on the device state information (step ST101), and if the master command MCD does not need to be relayed, the power controller 104 sets the power mode of the interface circuit 102 to the low power mode (step ST102). If the master command MCD needs to be relayed, the power controller 104 sets the power mode of the interface circuit 102 to the normal power mode (step ST103). Next, the command determiner 103 confirms whether or not it has received the master command MCD from the master device 10 (step ST104). If the command determiner 103 has not received the master command MCD from the master device 10, the process goes to step ST101, and steps ST101-ST103 are performed again. If the command determiner 103 has received the master command MCD from the master device 10, the command determiner 103 and the response controller 105 operate in response to the determination result at step ST101 (step ST105). If the master command MCD does not need to be relayed, the command determiner 103 does not send the master command MCD to the slave device 20, and the response controller 105 sends a substitute command corresponding to the master command MCD as a slave command SCD to the master device 10 (step ST106). If the master command MCD needs to be relayed, the command determiner 103 sends the master command MCD to the slave device 20, and the response controller 105 sends the slave command SCD sent from the slave device 20 to the master device 10 (step ST107). Next, if the interface device 1 continuously operates, the process goes to step ST101 (step ST108).

### Specific Examples

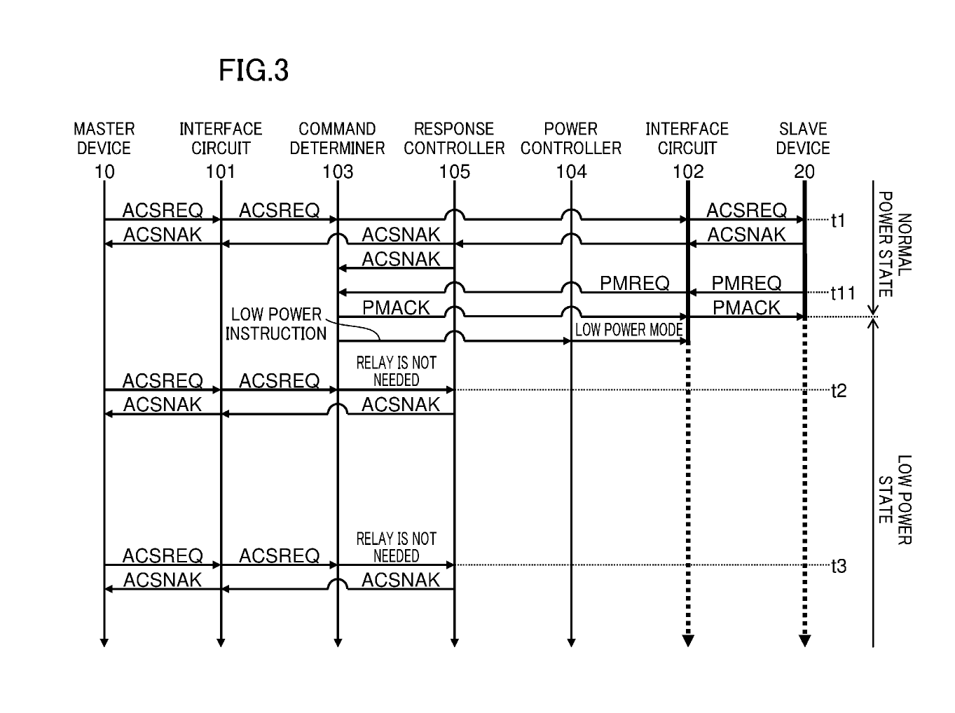

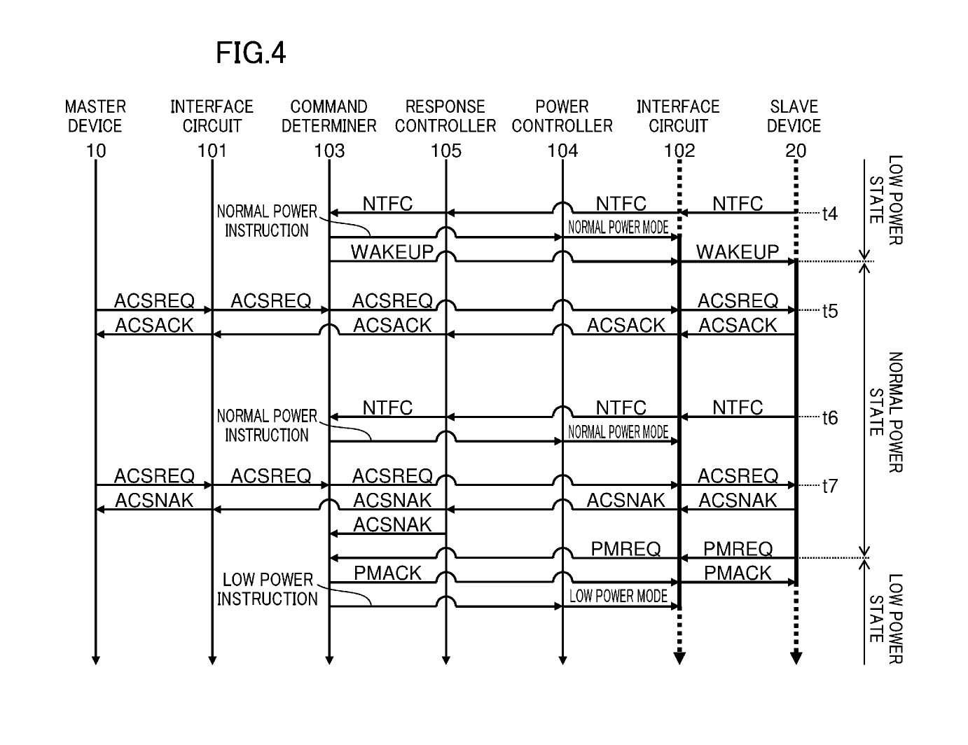

Next, the operation of the interface device 1 will be specifically described with reference to FIGS. 3 and 4. It is assumed that the interface 200 is a serial ATA interface, and the slave device 20 sends (asynchronous notification), to the interface circuit 102, a status notification command NTFC specifying the change of its operational state. The status notification command NTFC can be sent to the response controller 105 through the interface circuit 102 even if the power mode of the interface circuit 102 is set to the low power mode. It is assumed that the slave device 20 is in an operational state which does not allow the access to the device 20 during times t1-t4 and after time t6, and the slave device 20 is in an operational state which allows the access to the device 20 during times t4-t6.

At time t1, the master device 10 sends an access request command ACSREQ as a master command MCD. The command determiner 103 sends the access request command ACSREQ, which the command determiner 103 has received through the interface circuit 101, to the slave device 20 through the interface circuit 102. The slave device 20 sends, as the slave command SCD, an access negative acknowledgement command ACSNAK specifying that the device 20 is in the operational state which does not allow the access to the device 20. The response controller 105 sends an access negative acknowledgement command ACSNAK, which the response controller 105 has received through the interface circuit 102, to the master device 10 through the interface circuit 101. With this sending, the master device 10 confirms that the slave device 20 is in the operational state which does not allow the access to the device 20. The response controller 105 notifies the command determiner 103 that the response controller 105 has received the access negative acknowledgement command ACSNAK. The command determiner 103 confirms that the slave device 20 is in the operational state which does not allow the access to the slave device 20 in response to the notification from the response controller 105 (notification of receiving the access negative acknowledgement command ACSNAK), and determines that the access request command ACSREQ does not need to be relayed from the master device 10 to the slave device 20.

At time t11, the slave device 20 sends a power management request command PMREQ. The command determiner 103 receives the power management request command PMREQ through the interface circuit 102 and sends a power management acknowledgement command PMACK to the slave device 20 through the interface circuit 102 in response to the power management request command PMREQ. With this sending, the power mode of the slave device 20 transitions from the normal power mode to the low power mode. Since the command determiner 103 determines that the access request command ACSREQ does not need to be relayed from the master device 10 to the slave device 20, the command determiner 103 notifies the power controller 104 of a power control instruction (low power instruction) for instructing the power controller 104 to set the power mode of the interface circuit 102 to the low power mode. The power controller 104 allows the power mode of the interface circuit 102 to transition from the normal power mode to the low power mode in response to the notification from the command determiner 103 (in other words, the determination result by the command determiner 103).

At time t2, the master device 10 sends the access request command ACSREQ, again. At this time, the command determiner 103 determines that the access request command ACSREQ does not need to be relayed, and therefore, does not send the access request command ACSREQ to the slave device 20. The response controller 105 selects an access negative acknowledgement command ACSNAK corresponding to the access request command ACSREQ as a substitute command, and sends the substitute command (in other words, the access negative acknowledgement command ACSNAK) to the master device 10 through the interface circuit 101. For example, in the command mapping table of the response controller 105, the access negative acknowledgement command ACSNAK corresponds to the access request command ACSREQ. After the response controller 105 sends the substitute command (in other words, the access negative acknowledgement command ACSNAK), the master device 10 confirms that the slave device 20 is in the operational state which does not allow the access to the slave device 20, again. If the command determiner 103 determines that the access request command ACSREQ does not need to be relayed, and receives the access request command ACSREQ from the master device 10, the command determiner 103 may notify the response controller 105 of a response control instruction for instructing sending the substitute command. In this case, the response controller 105 may send the substitute command in response to the notification from the command determiner 103 (in other words, the determination result by the command determiner 103).

As well as time t2, at time t3, the access request command ACSREQ from the master device 10 is not sent to the slave device 20, and the response controller 105 sends the access negative acknowledgement command ACSNAK corresponding to the access request command ACSREQ to the master device 10.

At time t4, the slave device 20 is in the operational state which allows the access to the slave device 20, and sends a status notification command NTFC specifying that the operational state of the slave device 20 has been changed. The response controller 105 receives the status notification command NTFC through the interface circuit 102, and then, notifies the command determiner 103 that the response controller 105 has received the status notification command NTFC. The command determiner 103 confirms that the operational state of the slave device 20 has been changed based on the notification from the response controller 105 (a receipt notification of the status notification command NTFC), and determines that the access request command ACSREQ needs to be relayed from the master device 10 to the slave device 20. The command determiner 103 notifies the power controller 104 of a power control instruction (normal power instruction) for instructing the power controller 104 to set the power mode of the interface circuit 102 to the normal power mode. The power controller 104 allows a transition of the power mode of the interface circuit 102 from the low power mode to the normal power mode in response to the notification from the command determiner 103. The command determiner 103 sends a return instruction command WAKEUP returning the slave device 20 from the low power mode to the normal power mode to the slave device 20 through the interface circuit 102. After the slave device 20 receives the return instruction command WAKEUP, the power mode of the slave device 20 transitions from the low power mode to the normal power mode.

At time t5, the master device 10 sends an access request command ACSREQ as a master command MCD. At this time, the command determiner 103 determines that the access request command ACSREQ needs to be relayed, and therefore, sends the access request command ACSREQ to the slave device 20 through the interface circuit 102. The slave device 20 sends, as a slave command SCD, the access acknowledgement command ACSACK specifying that the slave device 20 is in the operational state which allows the access to the slave device 20. The response controller 105 sends the access acknowledgement command ACSACK, which the response controller 105 has received through the interface circuit 102, to the master device 10 through the interface circuit 101. With this sending, the master device 10 confirms that the slave device 20 is in the operational state which allows the access to the slave device 20.

At time t6, the slave device 20 is in the operational state which does not allow the access to the slave device 20, and sends a status notification command NTFC specifying that the operational state of the slave device 20 has been changed. The response controller 105 receives the status notification command NTFC through the interface circuit 102, and then, notifies the command determiner 103 that the response controller 105 has received the status notification command NTFC. The command determiner 103 determines that the access request command ACSREQ needs to be relayed from the master device 10 to the slave device 20 based on the notification from the response controller 105, and notifies the power controller 104 of a power control instruction (normal power instruction) for instructing the power controller 104 to set the power mode of the interface circuit 102 to the normal power mode. The power mode of the interface circuit 102 has already been set to the normal power mode, and therefore, the power controller 104 continuously sets the power mode of the interface circuit 102 to the normal power mode.

At time t7, as well as time t1, the master device 10 sends an access request command ACSREQ, and the command determiner 103 sends the access request command

ACSREQ, which the command determiner 103 has received through the interface circuit 101, to the slave device 20 through the interface circuit 102. The slave device 20 sends an access negative acknowledgement command ACSNAK, and the response controller 105 sends the access negative acknowledgement command ACSNAK, which the response controller 105 has received through the interface circuit 102, to the master device 10 through the interface circuit 101. With this sending, the master device 10 confirms that the slave device 20 is in the operational state which does not allow the access to the slave device 20. The response controller 105 notifies the command determiner 103 that the response controller 105 has received the access negative acknowledgement command ACSNAK, and the command determiner 103 determines that the access request command ACSREQ does not need to be relayed from the master device 10 to the slave device 20 based on the notification from the response controller 105. Then, as well as the case of time t11, the slave device 20 sends a power management request command PMREQ. When the slave device 20 receives a power management acknowledgement command PMACK from the command determiner 103, the power mode of the slave device 20 transitions from the normal power mode to the low power mode. The command determiner 103 notifies the power controller 104 of a power control instruction (low power instruction) for instructing the power controller 104 to set the power mode of the interface circuit 102 to the low power mode, and the power controller 104 allows a transition of the power mode of the interface circuit 102 from the normal power mode to the low power mode in response to the notification from the command determiner 103.

Device State Information

Like the above specific example, when the interface 200 is a serial ATA interface (in other words, when the slave device 20 and the interface circuit 102 perform an operation in accordance with the serial ATA standard), the command determiner 103 can utilize the notification from the response controller 105 (in this case, the receipt notification of the access negative acknowledgement command ACSNAK and the receipt notification of the status notification command NTFC) as device state information (information specifying the operational state of the slave device 20). The command determiner 103 may receive specific information (in this case, the access negative acknowledgement command ACSNAK and the status notification command NTFC) that has been sent from the slave device 20 through the interface circuit 102 as device state information.

The slave device 20 may send the status notification command NTFC to the interface circuit 102 through a device present (DP) signal line of signal lines included in the serial ATA interface. In many cases, such a DP signal line is included in, e.g., a power cable of a storage device of compact type as a signal line different from a signal line used for sending or receiving data regarding a storage medium. Even if the interface 200 is not a serial ATA interface but another interface, it is possible to send specific information that is available as the device state information from the slave device 20 to the response controller 105 (or the command determiner 103) through the interface circuit 102.

Access Possibility

Here, the operational state which allows the access to the slave device 20 and the operational state which does not allow the access to the slave device 20 will be described using examples.

Whether or not Storage Medium is Loaded

A case where the slave device 20 includes a storage device in which a storage medium can be loaded will be described. In this case, “the operational state which allows the access to the slave device 20” corresponds to a state where a storage medium is loaded in the storage device, and “the operational state which does not allow the access to the slave device 20” corresponds to a state where a storage medium is not loaded in the storage device. In this case, the access request command ACSREQ corresponds to a command inquiring whether or not a storage medium is loaded in the storage device, the access negative acknowledgement command ACSNAK corresponds to a command specifying that a storage medium is not loaded in the storage device, and the access acknowledgement command ACSACK corresponds to a command specifying that a storage medium is loaded in the storage device. The command determiner 103 determines that the master command MCD needs to be relayed if a storage medium is loaded in the storage device, and determines that the master command MCD does not need to be relayed if a storage medium is not loaded in the storage device.

Spin Up

Next, a case where the slave device 20 includes a storage device which spins up the storage medium to read or write data of the storage medium will be described. In this case, “the operational state which allows the access to the slave device 20” corresponds to a state where the spin up of the storage medium is completed, “the operational state which does not allow the access to the slave device 20” corresponds to a state where the spin up of the storage medium is not completed. In this case, the access request command ACSREQ corresponds to a command requesting reading or writing data of the storage medium, the access negative acknowledgement command ACSNAK corresponds to a command specifying that the spin up of the storage medium is not completed (data cannot be read or written), and the access acknowledgement command ACSACK corresponds to a command specifying that the spin up of the storage medium is completed (data can be read or written). The command determiner 103 determines that the master command MCD needs to be relayed if the spin up of the storage medium is completed, and determines that the master command MCD does not need to be relayed if the spin up of the storage medium is not completed.

### Comparative Examples

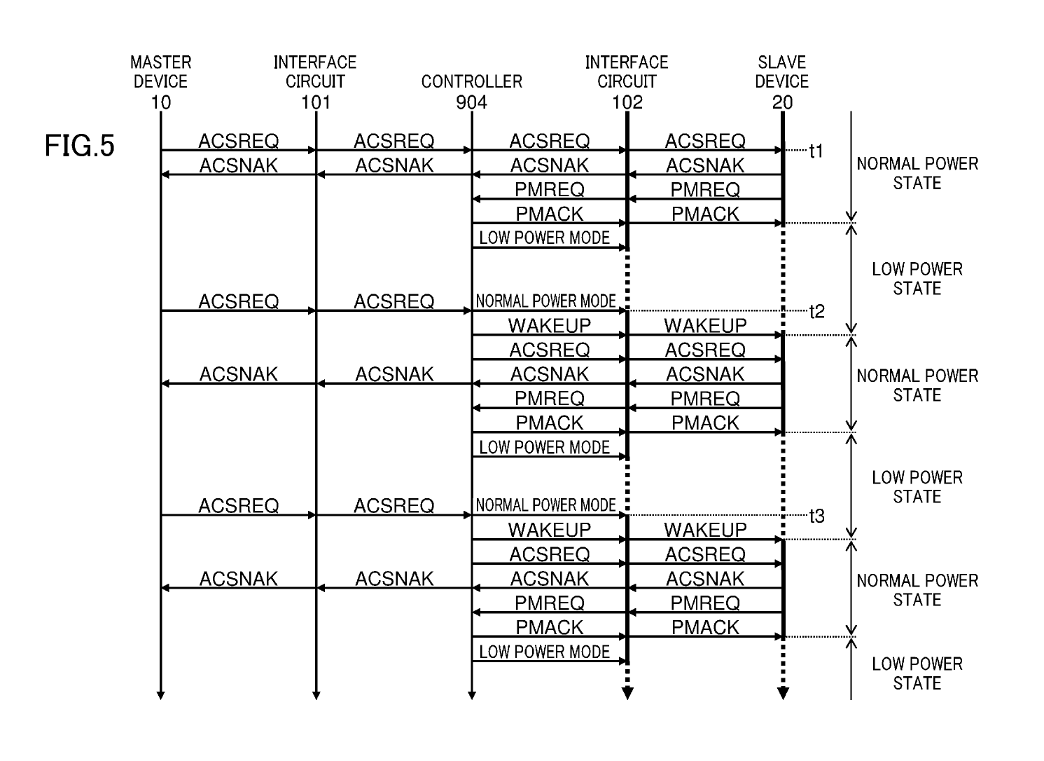

Next, comparative example of the interface device 1 (an interface device no function of determining whether or not the relay is needed and no representative response function) will be described with reference to FIG. 5. The interface device includes the command determiner 103 and the power controller 104 which are illustrated in FIG. 1, and a controller 904 instead of the response controller 105. The controller 904 controls the relay of the master command MCD, the relay of the slave command SCD, and the power of the interface circuit 102.

At time t1, the controller 904 sends the access request command ACSREQ, which the controller 904 has received through the interface circuit 101, to the slave device 20 through the interface circuit 102, and sends the access negative acknowledgement command ACSNAK, which the controller 904 has received through the interface circuit 102, to the master device 10 through the interface circuit 101. The controller 904, in response to the power management request command PMREQ, which the controller 904 has received through the interface circuit 102, sends a power management acknowledgement command PMACK to the slave device 20 through the interface circuit 102, and allows a transition of the power mode of the interface circuit 102 from the normal power mode to the low power mode.

At time t2, the master device 10 sends the access request command ACSREQ, again. At this time, in order to send the access request command ACSREQ to the slave device 20, the controller 904 allows a transition of the power mode of the interface circuit 102 from the low power mode to the normal power mode, and sends a return instruction command WAKEUP returning the slave device 20 from the low power mode to the normal power mode to the slave device 20 through the interface circuit 102. Then, as well as time t1, the controller 904 sends the access request command ACSREQ to the slave device 20 through the interface circuit 102, and sends the access negative acknowledgement command ACSNAK, which the controller 904 has received through the interface circuit 102, to the master device 10 through the interface circuit 101. As well as time t1, the controller 904, in response to the power management request command PMREQ, sends a power management acknowledgement command PMACK to the slave device 20, and allows a transition of the power mode of the interface circuit 102 from the normal power mode to the low power mode. The operation is performed at time t3 in the similar manner to the operation at times t1 and t2.

In this way, in the interface device having no function of determining whether or not the relay is needed and no representative response function, even if the slave device 20 is in the operational state which does not allow the access to the slave device 20, the power mode of the slave device 20 is returned to the normal power mode whenever the access request command ACSREQ is sent from the master device 10. Therefore, the low power period of the interface circuit 102 (a period during which the interface circuit is maintained in the low power mode) is intermittent, and it is difficult to efficiently reduce power consumed by the interface device 102.

In contrast, in the interface device 1 illustrated in FIG. 1, like FIG. 3, if the slave device 20 is in the operational state which does not allow the access to the slave device 20, the response controller 105, instead of the slave device 20, sends the access negative acknowledgement command ACSNAK corresponding to the access request command ACSREQ to the master device 10, and the power controller 104 maintains the power mode of the interface circuit in the low power mode. Therefore, even if the access request command ACSREQ is repeatedly sent from the master device 10, the power mode of the interface circuit 102 is maintained in the low power mode.

In this way, if the master command MCD does not need to be relayed, the substitute command corresponding to the master command MCD is sent, and therefore, the power mode of the interface circuit 102 may not be returned to the normal power mode in order to send the master command MCD to the slave device 20. Therefore, the low power period of the interface circuit 102 can be continuously ensured, whereby the power consumed by the interface circuit 102 can be efficiently reduced. As a result, the power consumed by the interface device 1 can be reduced.

If the master command MCD does not need to be relayed, the master command MCD is not sent from the master device 10 to the slave device 20, and therefore, the power mode of the slave device 20 may not be returned to the normal power mode. Therefore, the low power period of the slave device 20 can be continuously ensured, whereby the power consumed by the slave device 20 can be efficiently reduced.

Stepwise Power Control

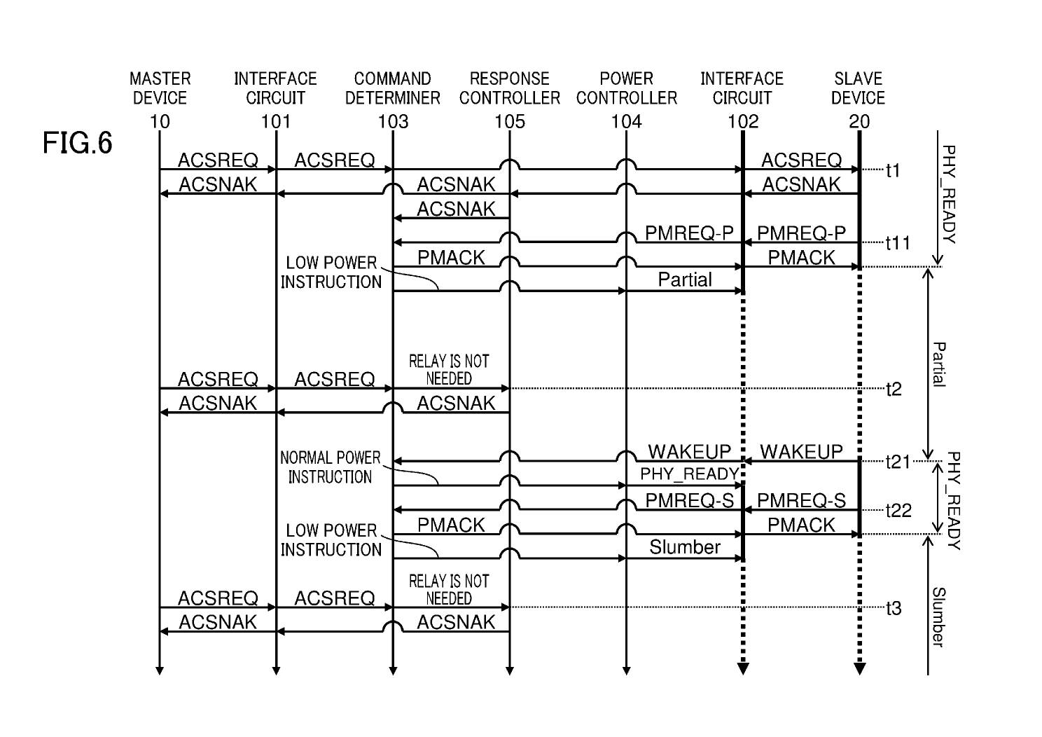

The power mode of the interface circuit 102 and the power mode of the slave device 20 may be gradually changed. For example, when the interface 200 is a serial ATA interface, the power mode of the interface circuit 102 and the power mode of the slave device 20 may be controlled like FIG. 6. Thus, at time t11, the slave device 20 sends a power management request command PMREQ-P requesting the transition to Partial mode, and the command determiner 103 sends the power management acknowledgement command PMACK to the slave device 20. As a result, the slave device 20 transitions from PHY_READY mode (the normal power mode) to Partial mode. The command determiner 103 notifies the power controller 104 of a power control instruction (a first low power instruction) for instructing setting the power mode of the interface circuit 102 to Partial mode (a first low power mode). The power controller 104 allows a transition of the power mode of the interface circuit 102 from PHY_READY mode to Partial mode. Next, at time t21, the slave device 20 sends the return instruction command WAKEUP to the command determiner 103 through the interface circuit 102, and the command determiner 103 notifies the power controller 104 of a power control instruction (normal power instruction) instructing setting the power mode of the interface circuit 102 to PHY_READY mode. The power controller 104 returns the power mode of the interface circuit 102 to PHY_READY mode. At time t22, the slave device 20 sends a power management request command PMREQ-S requesting a transition to Slumber mode, and the command determiner 103 sends the power management acknowledgement command PMACK to the slave device 20. As a result, the slave device 20 transitions from PHY_READY mode to Slumber mode. The command determiner 103 notifies the power controller 104 of a power control instruction (a second low power instruction) for instructing setting the power mode of the interface circuit 102 to Slumber partial mode (a second low power mode). The power controller 104 allows a transition of the power mode of the interface circuit 102 from PHY_READY mode to Slumber mode.

### Second Embodiment

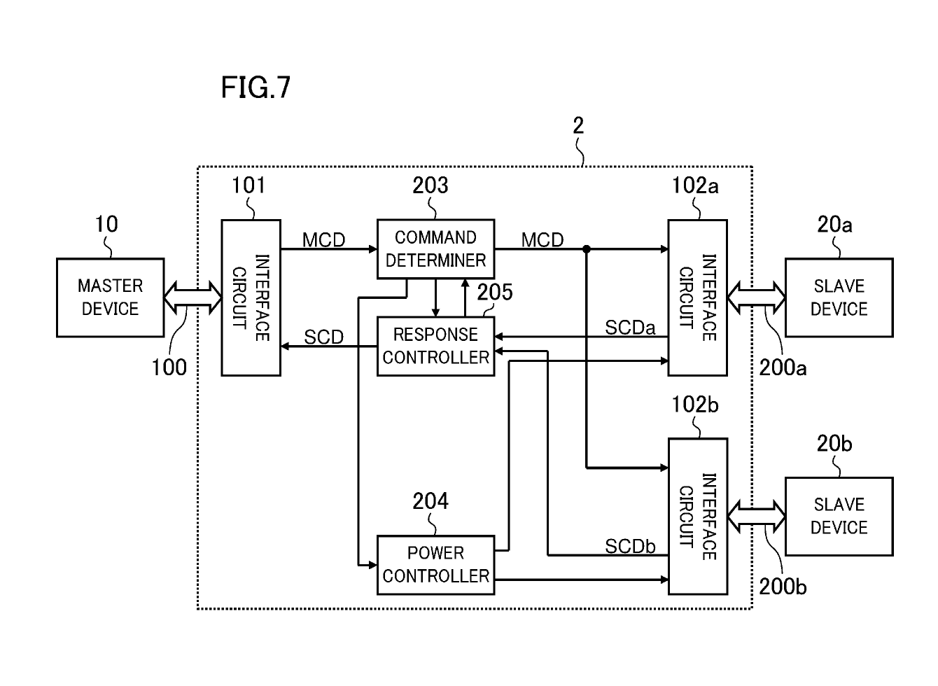

FIG. 7 illustrates an example configuration of an interface device according to a second embodiment. The interface device 2 interfaces between the master device 10 and a plurality of slave devices (in this embodiment, slave devices 20a and 20b), and includes an interface circuit 101, a plurality of interface circuits (in this embodiment, interface circuits 102a and 102b), a command determiner 203, a power controller 204, a response controller 205.

Interface Circuit

The interface circuits 102a and 102b are respectively connected to the slave devices 20a and 20b through interfaces 200a and 200b. Each of the interface circuits 102a and 102b is switchable between a normal power mode and a low power mode as well as the interface circuit 102. Each of the slave devices 20a and 20b is also switchable between the normal power mode and the low power mode as well as the slave device 20.

Command Determiner

The command determiner 203 determines whether or not the master command MCD needs to be relayed from the master device 10 to each of the slave devices 20a and 20b based on device state information specifying the operational state of each of the slave devices 20a and 20b. The command determiner 203 controls the relay of the master command MCD from the master device 10 to each of the slave devices 20a and 20b in response to the determination result of necessity of the relay regarding each of the slave devices 20a and 20b. If one of the slave devices 20a and 20b which has been determined to need the relay of the master command MCD is designated as a command destination of the master device 10, the command determiner 203 sends the master command MCD, which the command determiner 203 has received from the master device 10 through the interface circuit 101, to the one of the slave devices 20a and 20b through a corresponding one of the interface circuits 102a and 102b. If one of the slave devices 20a and 20b which has been determined not to need the relay of the master command MCD is designated as a command destination of the master device 10, the command determiner 203 does not send the master command MCD, which the command determiner 203 has received from the master device 10 through the interface circuit 101, to the one of the slave devices 20a and 20b.

Power Controller

The power controller 204 controls the power modes of the interface circuits 102a and 102b in response to the determination result by the command determiner 203. The power controller 204 sets the power mode of one or more of the interface circuits 102a and 102b which corresponds to one or more of the slave devices 20a and 20b which has been determined to need the relay of the master command MCD to the normal power mode. The power controller 204 sets the power mode of one or more of the interface circuits 102a and 102b which corresponds to one or more of the slave devices 20a and 20b which has been determined not to need the relay of the master command MCD to the low power mode.

Response Controller The response controller 205 controls the relay of slave commands SCDa and SCDb from the slave devices 20a and 20b to the master device 10 in response to the determination result by the command determiner 203. If one of the slave devices 20a and 20b which has been determined to need the relay of the master command MCD is designated as a command destination of the master device 10, the response controller 205 sends the slave command SCDa (or SCDb), which the response controller 205 has received from the one of the slave device 20a (or 20b) through a corresponding one of the interface circuits 102a and 102b, to the master device 10 through the interface circuit 101. If one of the slave devices 20a and 20b which has been determined not to need the relay of the master command MCD is designated as a command destination of the master device 10, the response controller 205 sends a substitute command corresponding to the master command MCD, which the command determiner 203 has received from the master device 10 through the interface circuit 101, as the slave command SCDa (or SCDb) to the master device 10 through the interface circuit 101.

Operation

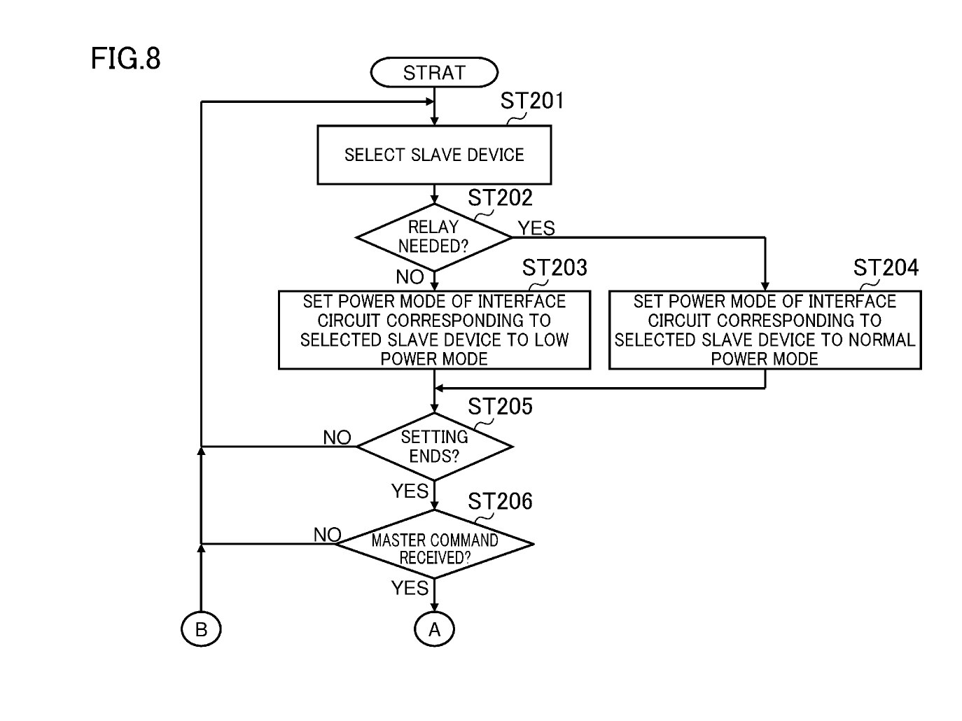

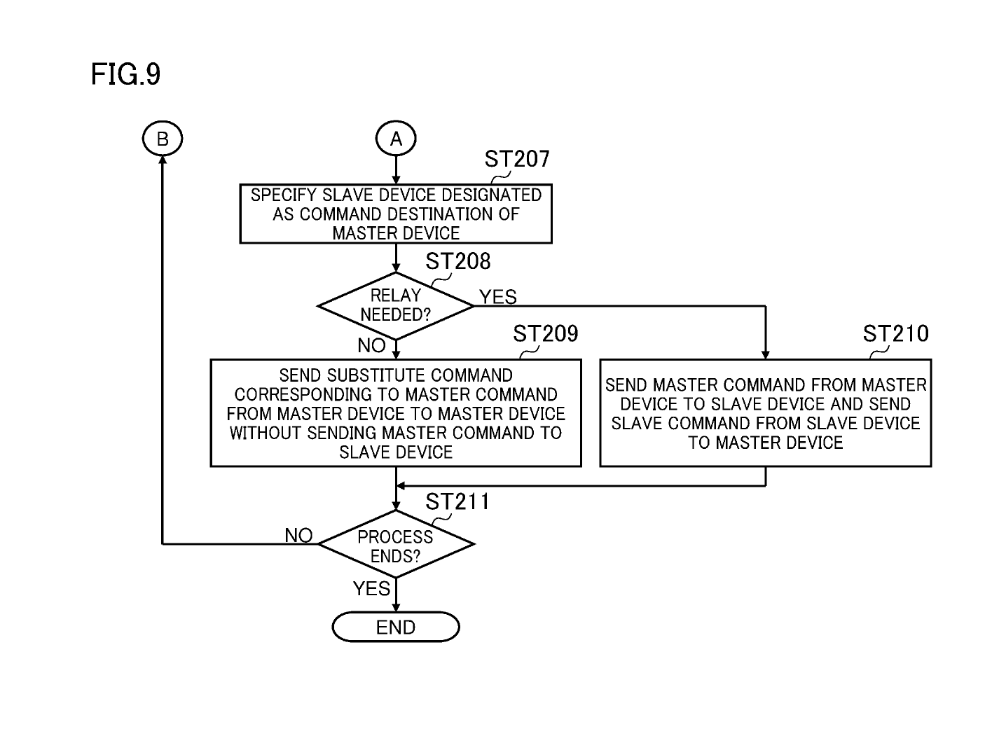

Next, the operation of the interface device 2 will be described with reference to FIGS. 8 and 9. The command determiner 203 selects one of the slave devices 20a and 20b which is to be determined to need the relay of the master command MCD (step ST201) and determines whether or not the master command MCD needs to be relayed from the master device 10 to the selected slave device which is to be determined (step ST202). If the master command MCD does not need to be relayed, the power controller 204 sets the power mode of one of the interface circuits 102a and 102b corresponding to the selected slave device to the low power mode (step ST203). If the master command MCD needs to be relayed, the power controller 204 sets the power mode of the one of the interface circuits 102a and 102b corresponding to the selected slave device to the normal power mode (step ST204). Next, the command determiner 203 determines whether to select the other of the slave devices 20a and 20b as a device which is to be determined to need the relay (in other words, whether or not the setting of the power mode of the interface circuits 102a and 102b ends) (step ST205). If the setting of the power mode of the interface circuits 102a and 102b does not end, the process goes to step ST201, and steps ST201-ST204 are performed again. If the setting of the power mode of the interface circuits 102a and 102b ends, the command determiner 203 confirms whether or not the command determiner 203 has received the master command MCD from the master device 10 (step ST206). If the command determiner 203 has not received the master command MCD from the master device 10, the process goes to the step ST201, and steps ST201-ST205 are performed, again.

If the command determiner 203 has received the master command MCD from the master device 10, the command determiner 203 specifies, of the slave devices 20a and 20b, a slave device designated as a command destination of the master device 10 based on the master command MCD from the master device 10 (step ST207). Next, the command determiner 203 and the response controller 205 operate in response to the determination result in step ST202 regarding the slave device that is the command destination (step ST208). If the master command MCD does not need to be relayed from the master device 10 to the slave device that is the command destination, the command determiner 203 does not send the master command MCD to the slave device that is a command destination, and the response controller 205 sends a substitute command corresponding to the master command MCD as a slave command (SCDa or SCDb) from the slave device that is the command destination to the master device 10 (step ST209). If the master command MCD needs to be relayed from the master device 10 to the slave device that is the command destination, the command determiner 203 sends the master command MCD to the slave device that is a command destination, and the response controller 205 sends the slave command (SCDa or SCDb) from the slave device that is the command destination to the master device 10 (step ST210). Next, if the operation by the interface device 2 is continuously performed, the process goes to step ST201 (step ST211).

In this way, if the master command MCD does not need to be relayed, a substitute command is sent, and therefore, the power mode of the interface circuit 102a (or 102b) may not be returned to the normal power mode in order to send the master command MCD to the slave device 20a (or 20b) designated as the command destination of the master command MCD. Therefore, since the low power period of the interface circuit 102a (or 102b) can be continuously ensured, the power consumed by the interface circuit 102a (or 102b) can be efficiently reduced, and as a result, the power consumed by the interface device 2 can be reduced.

If the master command MCD does not need to be relayed, the master command MCD from the master device 10 is not sent to the slave device 20a (or 20b) designated as the command destination of the master command MCD, and therefore, the power mode of the slave device 20a (or 20b) may not be returned to the normal power mode. Therefore, the low power period of the slave device 20a (or 20b) can be continuously ensured, and as a result, the power consumed by the slave device 20a (or 20b) can be reduced.

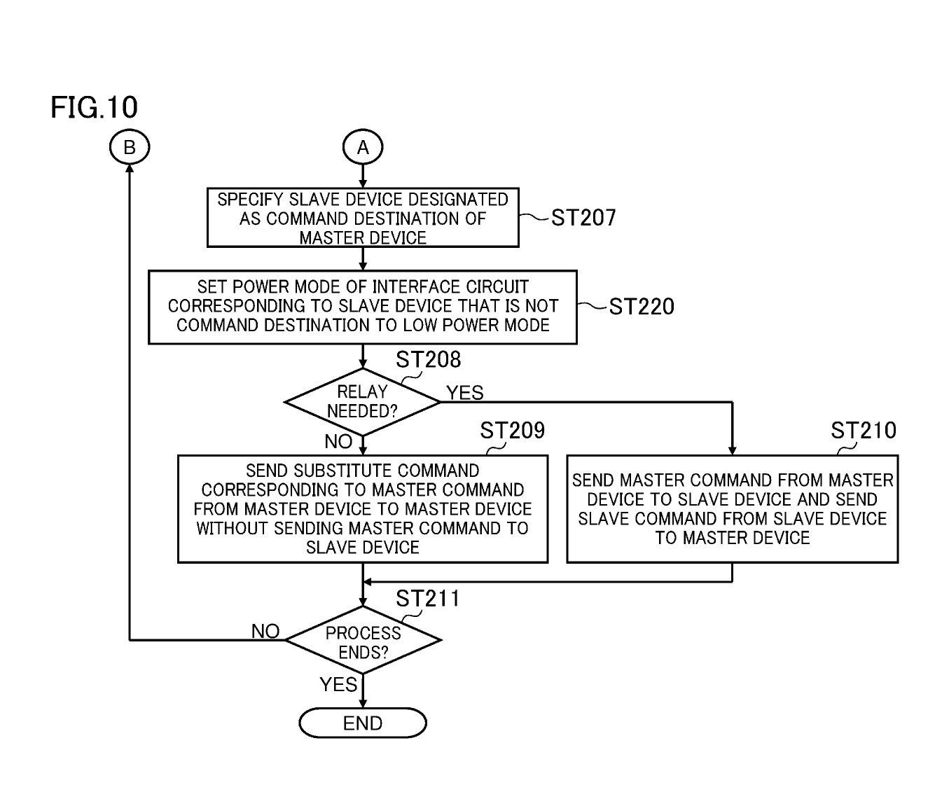

As illustrated in FIG. 10, the power controller 204 may set the power mode of one or more of the interface circuits 102a and 102b which does not correspond to the slave device that is a command destination to the low power mode (at step ST220). With such a control, the power consumed by the interface circuit corresponding to the slave device that is not designated as a command destination, whereby the power consumed by the interface device 2 can be further reduced.

As stated above, the interface device described above can efficiently reduce power consumption, and therefore, it is useful as a device interfacing between a master device (for example, a host computer) and a slave device (for example, a peripheral device such as an external storage device).

It should be noted that the embodiments described above are essentially preferable illustrations and are by no means intended to limit the technology disclosed in this specification, applications thereof, or the scope of uses thereof.

What is claimed is:

1. An interface device interfacing between a master device and a slave device, the interface device comprising:
a first interface circuit connected to the master device through a first interface;
a second interface circuit connected to the slave device through a second interface, and switchable between a normal power mode and a low power mode;
a command determiner
configured to determine whether or not a master command needs to be relayed from the master device to the slave device based on device state information specifying an operational state of the slave device,
configured to send the master command, which the command determiner has received from the master device through the first interface circuit, to the slave device through the second interface circuit if the command determiner determines that the master command needs to be relayed, and
configured not to send the master command, which the command determiner has received from the master device through the first interface circuit, to the slave device if the command determiner determines that the master command does not need to be relayed;
a power controller
configured to set a power mode of the second interface circuit to the normal power mode if the command determiner determines that the master command needs to be relayed, and
configured to set the power mode of the second interface circuit to the low power mode if the command determiner determines that the master command does not need to be relayed; and
a response controller
configured to send a slave command, which the response controller has received from the slave device through the second interface circuit, to the master device through the first interface circuit if the command determiner determines that the master command needs to be relayed, and
configured to send, as the slave command, a substitute command corresponding to the master command, which the command determiner has received from the master device through the first interface circuit, to the master device through the first interface circuit if the command determiner determines that the master command does not need to be relayed.

2. The interface device of claim 1, wherein
the device state information specifies whether or not access to the slave device is allowed, and
the command determiner is configured to determine that the master command needs to be relayed if the slave device is in an operational state which allows the access to the slave device, and is configured to determine that the master command does not need to be relayed if the slave device is in an operational state which does not allow the access to the slave device.

3. The interface device of claim 2, wherein
the slave device includes a storage device in which a storage medium is loadable,
the device state information specifies whether or not the storage medium is loaded in the storage device, and
the command determiner is configured to determine that the master command needs to be relayed if the storage medium is loaded in the storage device, and is configured to determine that the master command does not need to be relayed if the storage medium is not loaded in the storage device.

4. The interface device of claim 2, wherein
the slave device includes a storage device which spins up a storage medium to read or write data of the storage medium,
the device state information specifies whether or not the spin up of the storage medium has been completed, and
the command determiner is configured to determine that the master command needs to be relayed if the spin up of the storage medium has been completed, and is configured to determine that the master command does not need to be relayed if the spin up of the storage medium has not been completed.

5. The interface device of claim 1, wherein
the response controller includes a command mapping table associating the master command from the master device with the slave command from the slave device, and is configured to select, from the command mapping table, as the substitute command, the slave command corresponding to the master command, which the command determiner has received from the master device through the first interface circuit, if the command determiner determines that the master command does not need to be relayed.

6. An interface device interfacing between a master device and a plurality of slave devices, the interface device comprising:
a first interface circuit connected to the master device through a first interface;
a plurality of second interface circuits each connected to a corresponding one of the slave devices through a corresponding one of a plurality of second interfaces and switchable between a normal power mode and a low power mode;
a command determiner
configured to determine whether or not a master command needs to be relayed from the master device to each of the slave devices based on device state information specifying an operational state of each of the slave devices,
configured to send the master command, which the command determiner has received from the master device through the first interface circuit, to one of the slave devices which has been determined to need a relay of the master command through a corresponding one of the second interface circuits if the one of the slave devices is designated as a command destination of the master device, and
configured not to send the master command, which the command determiner has received from the master device through the first interface circuit, to one of the slave devices which has been determined not to need a relay of the master command if the one of the slave devices is designated as a command destination of the master device;
a power controller
configured to set a power mode of one or more of the second interface circuits corresponding to one or more of the slave devices which have been determined to need the relay of the master command to the normal power mode, and
configured to set a power mode of one or more of the second interface circuits corresponding to one or more of the slave devices which have been determined not to need the relay of the master command to the low power mode; and
a response controller
configured to send a slave command, which the response controller has received from the one of the slave devices which has been determined to need the relay of the master command through the corresponding one of the second interface circuits, to the master device through the first interface circuit if the one of the slave devices is designated as a command destination of the master device, and
configured to send, as the slave command, a substitute command corresponding to the master command, which the command determiner has received from the master device through the first interface circuit, to the master device through the first interface circuit if the one of the slave devices which has been determined not to need the relay of the master command is designated as a command destination of the master device.

7. The interface device of claim 6, wherein
the power controller is configured to set the power mode of the one of the second interface circuits corresponding to the one of the slave devices which has been designated as the command destination of the master device to the normal power mode, and is configured to set the power mode of the one or more of the second interface circuits corresponding to the one or more of the slave devices which have not been designated as the command destination of the master device to the low power mode.

8. The interface device of claim 1, wherein
the first and second interfaces are serial ATA interfaces.

9. A method of interfacing between a master device and a slave device by using an interface device which includes a first interface circuit connected to the master device through a first interface, and a second interface circuit connected to the slave device through a second interface and switchable between a normal power mode and a low power mode, the method comprising the steps of:
(a) determining whether or not a master command needs to be relayed from the master device to the slave device based on device state information specifying an operational state of the slave device;
(b) setting a power mode of the second interface circuit to the normal power mode if it is determined that the master command needs to be relayed in the step (a), and setting the power mode of the second interface circuit to the low power mode if it is determined that the master command does not need to be relayed in the step (a);
(c) sending the master command, which has been received from the master device through the first interface circuit, to the slave device through the second interface circuit, and sending a slave command, which has been received from the slave device through the second interface circuit, to the master device through the first interface circuit, if it is determined that the master command needs to be relayed in the step (a); and
(d) sending, as the slave command, a substitute command corresponding to the master command, which has been received from the master device through the first interface circuit, to the master device through the first interface circuit without sending the master command to the slave device, if it is determined that the master command does not need to be relayed in the step (a).

10. The method of claim 9, wherein
the device state information specifies whether or not access to the slave device is allowed, and
in the step (a), it is determined that the master command needs to be relayed if the slave device is in an operational state where the access to the slave device is allowed, and it is determined that the master command does not need to be relayed if the slave device is in an operational state where the access to the slave device is not allowed.

11. The method of claim 10, wherein
the slave device includes a storage device in which a storage medium is loadable,
the device state information specifies whether or not the storage medium is loaded in the storage device,
in the step (a), it is determined that the master command needs to be relayed if the storage medium is loaded in the storage device, and it is determined that the master command does not need to be relayed if the storage medium is not loaded in the storage device.

12. The method of claim 10, wherein
the slave device includes a storage device which spins up a storage medium to read or write data of the storage medium,
the device state information specifies whether or not the spin up of the storage medium has been completed,
in the step (a), it is determined that the master command needs to be relayed if the spin up of the storage medium has been completed, and it is determined that the master command does not need to be relayed if the spin up of the storage medium has not been completed.

13. A method of interfacing between a master device and a plurality of slave devices by using an interface device which includes a first interface circuit connected to the master device through a first interface, and a plurality of second interface circuits each connected to a corresponding one of the slave devices through a corresponding one of a plurality of second interfaces and switchable between a normal power mode and a low power mode, the method comprising the steps of:
(a) determining whether or not a master command needs to be relayed from the master device to each of the slave devices based on device state information specifying an operational state of each of the slave devices;
(b) setting a power mode of one or more of the second interface circuits corresponding to one or more of the slave devices which have been determined to need the relay of the master command in the step (a) to the normal power mode, and setting a power mode of one or more of the second interface circuits corresponding to one or more of the slave devices which have been determined not to need the relay of the master command in the step (a) to the low power mode;
(c) sending the master command, which has been received from the master device through the first interface circuit, to the one of the slave devices through the corresponding one of the second interface circuits, and sending a slave command, which has been received from the one of the slave devices through the corresponding one of the second interface circuits, if the one of the slave devices which has been determined to need the relay of the master command in the step (a) is designated as a command destination of the master device; and
(d) sending, as the slave command, a substitute command corresponding to the master command, which has been received from the master device through the first interface circuit, to the master device through the first interface circuit without sending the master command to the one of the slave devices, if the one of the slave devices which has been determined not to need the relay of the master command in the step (a) is designated as a command destination of the master device.
